(19) United States
(12) Patent Application Publication
(10) Pub. No.: US 2025/0035900 A1
(43) Pub. Date: Jan. 30, 2025

(54) Optical System for Generating a 360° Laser Line

(71) Applicant: Hilti Aktiengesellschaft, Schaan (LI)

(72) Inventor: Lieu-Kim DANG, Gams (CH)

(21) Appl. No.: 18/710,830

(22) PCT Filed: Nov. 16, 2022
(86) PCT No.: PCT/EP2022/082054

§ 371 Date: May 16, 2024

(30) Foreign Application Priority Data
Nov. 17, 2021 (EP) 21208688.8

(51) Int. Cl. G02B 19/00; G01C 15/00; G02B 5/00

(52) U.S. Cl. CPC G02B 19/0071; G01C 15/004; G02B 5/001; G02B 19/0028

(57) ABSTRACT

An optical system for generating a 360° laser line includes a first cone optical unit, a second cone optical unit, and a third cone optical unit. The first cone optical unit is configured in a form of a first negative cone section with a first cone axis and has a conical first inner lateral surface with a first opening angle, a conical first outer lateral surface, and a first cone vertex. The second cone optical unit is configured in a form of a second negative cone section with a second cone axis and has a conical second inner lateral surface with a second opening angle and a second outer lateral surface. The third cone optical unit has a third cone axis, a cone shell with an opening angle, and a second cone vertex, where the opening angle of the cone shell differs from 90°.

### BACKGROUND AND SUMMARY OF THE INVENTION

The present invention relates to an optical system for generating a 360° laser line.

In order to carry out leveling or marking work indoors and outdoors, laser systems are known which generate a linear laser marking on a projection surface. In the case of these laser systems a distinction is drawn between rotary lasers, which generate the linear laser marking by rotation of a beam deflection optical unit about an axis of rotation, and line lasers, which generate the linear laser marking by means of a beam shaping optical unit, for example a cylindrical lens, a prism or a conical mirror. In order that the known laser systems can be used without protective measures in the form of protective goggles and reflectors, the laser power must be limited in order to prevent damage to the human eye. For laser systems in laser class 2 or 2M, the maximum permissible laser power is 1 mW.

As a result of the laser power being limited to values of less than 1 mW, known laser systems in laser class 2 or 2M have the disadvantage that the linear laser marking on the projection surface is poorly visible. It holds true here that the visibility of the linear laser marking is all the worse, the wider the laser marking on the projection surface, since the visibility decreases as the power density decreases. Moreover, the quality of the linear laser marking on the projection surface is dependent on the distance between the laser system and the projection surface.

EP 2 411 762 B1 discloses a laser system with an optical system for generating a 360° laser line. The laser system comprises a laser beam source, which generates a divergent laser beam and emits it along a propagation direction, a beam shaping optical unit, which is embodied as a collimation optical unit and reshapes the divergent laser beam into a collimated laser beam, and a conical mirror embodied as a right cone having a cone axis and a reflective lateral surface. The conical mirror is arranged in the beam path of the laser beam downstream of the collimation optical unit, and the cone axis is aligned coaxially to the optical axis of the collimation optical unit.

The laser system known from EP 2 411 762 B1 has the disadvantage that no sharply delimited laser line is generated on a projection surface. The laser line consists of a main line and at least one secondary line. The occurrence of a plurality of lines is caused by the fact that the laser beam source generates a laser beam having a plurality of orders of diffraction which are diffracted differently at the cone vertex of the conical mirror and occur as adjacent lines on the projection surface.

WO 2018/108411 A1 discloses a further known laser system with an optical system for generating a 360° laser line. The optical system has a first cone optical unit and a second cone optical unit. The first cone optical unit is designed in the form of a first negative cone section with a first cone axis and has a conical first inner lateral surface with a first opening angle, a conical first outer lateral surface, and a first cone vertex. The second cone optical unit is designed in the form of a second negative cone section with a second cone axis and has a conical second inner lateral surface with a second opening angle and a second outer lateral surface.

The laser system known from WO 2018/108411 A1 has the disadvantage that no sharply delimited laser line is generated on a projection surface. The laser line consists of a main line and at least one secondary line.

The object of the present invention is to develop an optical system with which a sharply delimited laser line with an opening angle of 360° can be generated on a projection surface.

According to the invention, the optical system is characterized by a further cone optical unit, which has a cone axis, a cone shell with an opening angle, and a cone vertex, wherein the opening angle of the cone shell differs from 90°.

The cone shell of the further cone optical unit is designed in such a way that its opening angle differs from 90° and the cone shell can act as beam splitting optical unit for an incident laser beam. At the cone vertex of the further cone optical unit, an incident laser beam is divided into two beam halves (left and right laser beam), which the optical system deflects along different paths. The two beam halves are each divided into a transmitted and a reflected partial beam.

The opening angle of the cone shell, which differs from 90°, ensures that the angles of incidence of the transmitted and reflected partial beams differ from each other and the dependence of the transmittance on the angle of incidence can be utilized. The deflected laser beam is composed of a transmitted partial beam of the one beam half and a reflected partial beam of the other beam half, so that the deflected laser beam which leaves the optical system has all diffraction orders and can generate a sharply delimited laser line with an opening angle of 360° on a projection surface.

The cone shell preferably has at an angle of incidence of 90°−α to the surface normal a ratio of transmittance T to reflectance R of T:R=50:50±10%. With a cone shell having an opening angle of 2*α, a laser beam is incident on the cone shell at an angle of incidence of 90°−α to the surface normal. The ratio T:R of 50:50±10% for the angle of incidence of 90°−α leads to the cone shell acting as a beam splitter and dividing the laser beam into a transmitted partial beam and a reflected partial beam. The radiant power of the transmitted partial beam is 50%±10%, and the radiant power of the reflected partial beam is 50%±10%; the loss due to absorption in the cone shell can be neglected.

The cone shell particularly preferably has at an angle of incidence of 3*α−90° to the surface normal a transmittance T of greater than 90%. With a cone shell having an opening angle of 2*α, the first-reflected partial beam is incident on the opposite side of the cone shell at an angle of incidence of 3*α−90° to the surface normal. The transmittance T being greater than 90% for the angle of incidence of 3*α−90° means that the reflected partial beam is mainly transmitted at the opposite side of the cone shell.

The deflected laser beam is composed of an upper partial beam and a lower partial beam, which are deflected along different paths by the optical system according to the invention. The optical system according to the invention has the advantage that the deflected laser beam has all orders of diffraction and therefore can generate a sharply delimited laser line on a projection surface.

Preferably the first opening angle of the first inner lateral surface corresponds with the opening angle of the cone shell. The partial beam transmitted through the cone shell is incident on the first inner lateral surface of the first cone optical unit. With an opening angle of the first inner lateral surface (first opening angle) of 2*α, total internal reflection occurs and the transmitted partial beam is reflected by total internal reflection at the first inner lateral surface.

Preferably, the first cone vertex of the first cone optical unit coincides with the cone vertex of the further cone optical unit. An optical system in which the first cone vertex coincides with the cone vertex of the further cone optical unit enables a compact construction of the optical system with a low height and can simplify the attachment of the various optical units.

Preferably, the first cone optical unit is integrated into a basic body, which has a conical recess for the further cone optical unit, wherein the conical shape of the recess corresponds to the further cone optical unit. The conical recess in the basic body is suitable as a receptacle for the further cone optical unit and enables a compact construction of the optical system with a low height and can simplify the attachment of the various optical units.

Particularly preferably, the second cone optical unit is integrated into the basic body and formed in one piece with the first cone optical unit. The one-piece design of the first and second cone optical units has the advantage that, after the production of the basic body, no adjustment of the first and second cone optical units relative to one another is necessary and there is no interface between the first cone optical unit and the second cone optical unit. Since the first and second cone optical units are made of the same optical material, temperature fluctuations affect the first and second cone optical units in the same way.

Preferably, the first cone axis of the first cone optical unit, the second cone axis of the second cone optical unit, and the cone axis of the further cone optical unit are arranged coaxially to one another. Due to the coaxial arrangement of the cone axes of the first, second and further cone optical units, a symmetric laser line with an opening angle of 360° can be generated and the radiant power of the laser beam can be distributed evenly over the opening angle of 360°.

The optical system preferably comprises a cylindrical optical unit, which is formed in one piece with the further cone optical unit. Owing to the cylindrical optical unit, the attachment of the various optical units of the optical system can be simplified. The cylindrical optical unit is formed in one piece with the further cone optical unit, which can be connected to the first and second cone optical units via a conical recess. The optical system merely requires a holder that can be attached to the lateral surface of the cylindrical optical unit.

The present application further relates to a laser system for generating a 360° laser line, which has a beam source and an optical system according to the invention. The beam source generates a laser beam that is deflected by the optical system.

The laser beam that the beam source generates preferably has a beam distribution in the form of a Gaussian distribution, a Lorentz distribution, or a Bessel distribution. These beam distributions do not exhibit an abrupt jump in intensity and help create a sharply delimited laser line on a projection surface.

Exemplary embodiments of the invention are described hereinafter with reference to the drawings. It is not necessarily intended for the drawings to illustrate the exemplary embodiments to scale; rather, the drawings are produced in a schematic and/or slightly distorted form where this is useful for the purposes of explanation. It should be taken into account here that various modifications and alterations relating to the form and detail of an embodiment may be undertaken without departing from the general concept of the invention. The general concept of the invention is not limited to the exact form or the detail of the preferred embodiment shown and described hereinafter or limited to a subject matter that would be restricted compared with the subject matter claimed in the claims. For given dimensioning ranges, values within the stated limits should also be disclosed as limit values and should be able to be used and claimed as desired. For the sake of simplicity, the same reference signs are used hereinafter for identical or similar parts or parts having an identical or similar function.

### BRIEF DESCRIPTION OF THE DRAWINGS

FIG. 1 shows a laser system according to the invention, which has a laser beam source, a collimation optical unit, and an optical system according to the invention;

FIGS. 2A, B show the optical system according to the invention of the laser system of FIG. 1, wherein the components are shown in the unconnected state (FIG. 2A) and in the connected state (FIG. 2B);

FIGS. 3A, B show the beam path of a left laser beam (FIG. 3A) and of a right laser beam (FIG. 3B) in the optical system according to the invention of FIG. 2;

FIG. 4 shows the optical system of FIG. 2 with a deflected laser beam composed of upper and lower partial beams;

FIG. 5 shows a further embodiment of an optical system according to the invention with a collimation optical unit, which is integrated into the optical system; and

FIGS. 6A, B show the beam path of a left laser beam (FIG. 6A) and of a right laser beam (FIG. 6B) in the optical system according to the invention of FIG. 5.

### DETAILED DESCRIPTION OF THE DRAWINGS

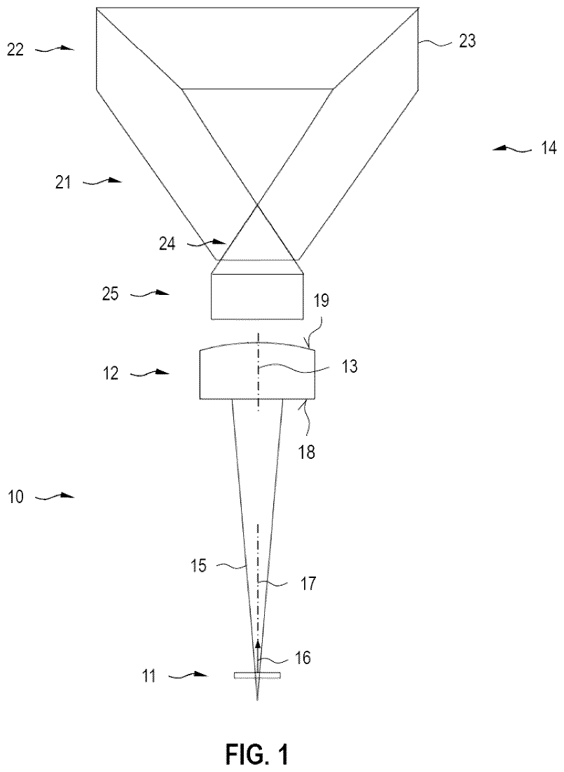

FIG. 1 shows a laser system 10 according to the invention for generating a 360° laser line on a projection surface. The laser system 10 comprises a laser beam source 11, a beam shaping optical unit 12, designed as a collimation optical unit, with an optical axis 13, and an optical system 14 according to the invention. The components of the laser system 10 are arranged in the order of laser beam source 11, beam shaping optical unit 12, and optical system 14.

The laser beam source 11 can be embodied as a semiconductor laser having a wavelength in the visible spectrum, for example as a red semiconductor laser having a wavelength of 635 nm or as a green semiconductor laser having a wavelength of between 510 and 555 nm. The properties of the further optical components 12, 14 of the laser system 10 are adapted to the wavelength of the laser beam source 11.

The laser beam source 11 generates a divergent laser beam 15, which is emitted along a propagation direction 16; without an additional optical element in the laser beam source 11, the laser beam 15 is divergent. The axis of symmetry of the beam distribution is defined as the optical axis 17 of the laser beam 15. The laser beam 15 preferably has a beam distribution in the form of a Gaussian distribution, a Lorentz distribution or a Bessel distribution. These beam distributions do not exhibit an abrupt jump in intensity and help create a sharply delimited laser line on a projection surface.

In the exemplary embodiment, the collimation optical unit 12 has a plane entrance surface 18 and a curved exit surface 19. Alternatively, the entrance surface 18 can be embodied as a curved surface and the exit surface 19 as a plane surface, or the entrance and exit surfaces 18, 19 are embodied as curved surfaces. The optical axis 13 of the collimation optical unit 12 is defined as a straight line which runs through the center of curvature of the curved surface and is perpendicular to the plane surface or, in the case of two curved surfaces, runs through the centers of curvature of the curved surfaces.

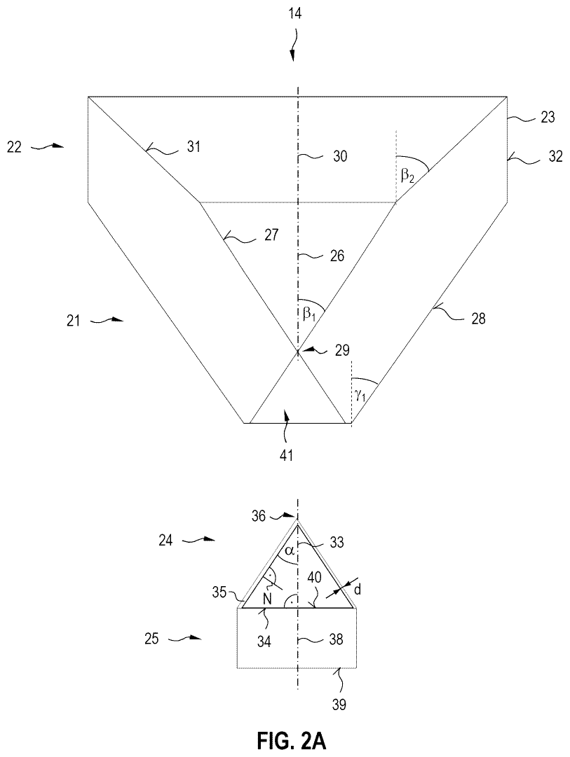

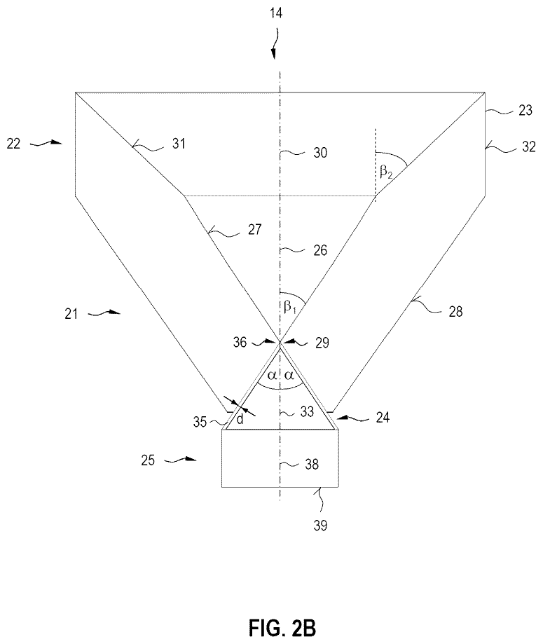

FIGS. 2A, B show the optical system 14 according to the invention of the laser system 10 in detail. The optical system 14 has a first cone optical unit 21 and a second cone optical unit 22, which are integrated into a basic body 23, and also a further cone optical unit 24 and a cylindrical optical unit 25, which is optional and simplifies the attachment of the further cone optical unit 24. FIG. 2A shows the basic body 23 with the first and second cone optical unit 21, 22 and the further cone optical unit 24 in an unconnected state, and FIG. 2B shows the further cone optical unit 24 which is connected to the basic body 23.

The first cone optical unit 21 is in the form of a first negative cone section having a first cone axis 26 and has a conical first inner lateral surface 27, a conical first outer lateral surface 28, and a first cone vertex 29. The first inner lateral surface 27 encloses a first beta angle β₁ with the first cone axis 26, and the first outer lateral surface 28 encloses a first gamma angle γ₁ with the first cone axis 26. The opening angle of the first inner lateral surface 27, which is referred to as the first opening angle, corresponds to twice the first beta angle 2*β₁, and the opening angle of the first outer lateral surface 28 corresponds to twice the first gamma angle 2*γ₁.

The second cone optical unit 22 is in the form of a second negative cone section having a second cone axis 30 and has a conical second inner lateral surface 31 and a second outer lateral surface 32. The second inner lateral surface 31 encloses a second beta angle β₂ with the second cone axis 30, and the opening angle of the second inner lateral surface 31, which is referred to as the second opening angle, corresponds to twice the second beta angle 2*β₂. The second outer lateral surface 32 is cylindrical in the exemplary embodiment and does not enclose an angle that is not equal to 0° with the second cone axis 30. Alternatively, the second outer lateral surface 32 can be conical and enclose an angle that is not equal to 0° with the second cone axis 30.

In the case of the optical system 14, the first and second cone optical units 21, 22 are integrated into the basic body 23 and are formed in one piece. The one-piece design of the first and second cone optical units 21, 22 has the advantage that, after the production of the basic body 23, the first and second cone optical units 21, 22 do not need to be adjusted relative to each other and there is no interface between the first cone optical unit 21 and the second cone optical unit 22. Since the first and second cone optical units 21, 22 are made of the same material, temperature fluctuations affect the first and second cone optical units 21, 22 in the same way. Alternatively, the first cone optical unit 21 and the second cone optical unit 22 can be formed in multiple pieces.

The further cone optical unit 24 is formed as a positive cone with a cone axis 33 and has a circular base 34, a cone shell 35 with a thickness d, and a cone vertex 36. The cone shell 35 encloses an alpha angle a with the cone axis 33, and the opening angle of the cone shell 35 corresponds to twice the alpha angle 2*α, wherein the opening angle 2*α of the cone shell 35 differs from 90°. The cone shell 35 is made of a material that differs from the other further cone optical unit 24 in at least one of the following properties: refractive index n, transmittance T, and reflectance R. The cone shell 35 can be applied, for example, as a coating; all dielectric materials and metals, for example silver (Ag), aluminum (Al), silver dioxide (SiO₂) and titanium dioxide (TiO₂) are suitable as materials for the cone shell 35.

The cylindrical optical unit 25 is cylindrical with a cylinder axis 38 and has a plane entrance surface 39 and a plane exit surface 40, which are designed for the wavelength and polarization of the laser beam source 11 as transmission surfaces. The transmittance T of the entrance and exit surfaces 39, 40 depends, among other things, on the angle of incidence and the polarization of an incident laser beam and on the refractive index n. Since the cylindrical optical unit 25 and further cone optical unit 24 are formed in one piece, the base 34 of the further cone optical unit 24 coincides with the exit surface 40 of the cylindrical optical unit 25. Glass, plastic, etc. are suitable materials for the cylindrical optical unit 25 and further cone optical unit 24.

The basic body 23 has a conical recess 41, which serves as a receptacle for the further cone optical unit 24. FIG. 2B shows the further cone optical unit 24, which is arranged in the recess 41 and is connected to the basic body 23. The further cone optical unit 24 is arranged in such a way that its cone vertex 36 faces the first cone vertex 29 of the first inner lateral surface 27 and coincides with it. In addition, the first opening angle 2*β₁ of the first inner lateral surface 27 and the opening angle 2*α of the cone shell 35 match.

The first opening angle 2*β₁ of the first inner lateral surface 27, the opening angle 2*γ₁ of the first outer lateral surface 28, and the second opening angle 2*β₂ of the second inner lateral surface 31 are matched to one another in such a way that an incident laser beam is deflected by a total of 90° and the partial beams are reflected by total internal reflection at the lateral surfaces 27, 28, 31.

The first cone optical unit 21, the second cone optical unit 22, and the further cone optical unit 24 are arranged such that the first cone axis 26, the second cone axis 30, and the cone axis 33 are arranged coaxially to one another. Due to the coaxial arrangement of the cone axes 26, 30, 37, a symmetric laser line with an opening angle of 360° can be generated and the radiant power of the laser beam can be distributed evenly over the opening angle of 360°.

During the production of the optical system 14, the cone shell 35 can be applied to the positive cone in a variant and fixed with the positive cone in the recess 41, for example by adhesive bonding with a suitable optical adhesive. Alternatively, the cone shell 35 can be applied in the recess 41, then the positive cone is attached to the cone shell 35, for example by adhesive bonding with a suitable optical adhesive.

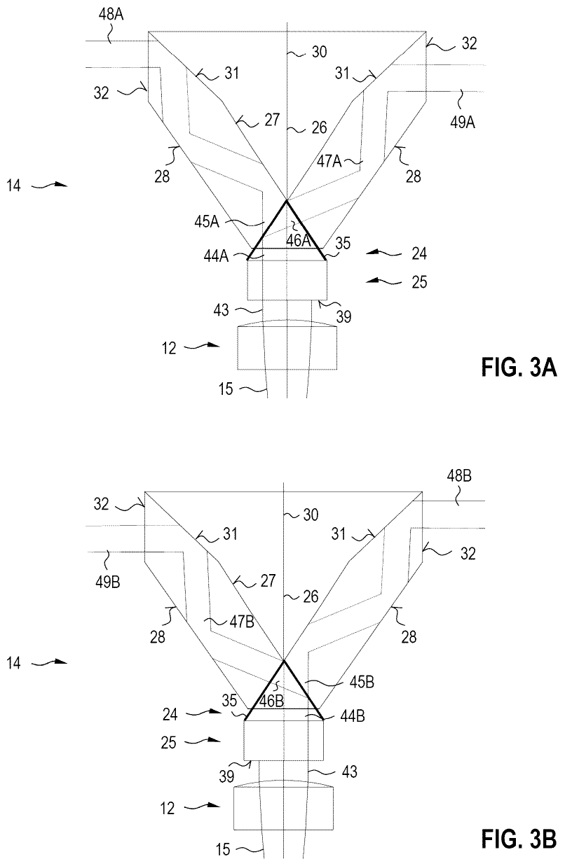

FIGS. 3A, B show the beam path of a laser beam in the optical system 14 according to the invention of the laser system 10 of FIG. 1. The optical system 14 comprises the first cone optical unit 21, the second cone optical unit 22, and the further cone optical unit 24.

The laser beam source 11 generates the divergent laser beam 15 which is incident on the collimation optical unit 12. The collimation optical unit 12 shapes the divergent laser beam 15 into a collimated laser beam 43, which is incident on the further cone optical unit 24. The collimated laser beam 43 is incident on the entrance surface 39 of the cylindrical optical unit 25, propagates through the cylindrical optical unit 25 and the further cone optical unit 24, and is incident on the cone shell 35.

The opening angle 2*α of the cone shell 35 differs from 90°, and the cone shell 35 acts as a beam splitting optical unit for the collimated laser beam 43. The laser beam 43 is divided by the cone vertex 36 into a left laser beam 44A and a right laser beam 44B. FIG. 3A shows the beam path of the left laser beam 44A, and FIG. 3B shows the beam path of the right laser beam 44B. The properties of the cone shell 35 and the opening angle 2*α are matched to one another in such a way that the incident laser beam 44A or 44B is divided into a transmitted partial beam 45A, 45B and a reflected partial beam 46A, 46B.

The angle of incidence is measured between the direction of incidence of the laser beams and the surface normal N. The left laser beam 44A and right laser beam 44B are each incident on the cone surface 35 at an angle of incidence of 90°−α to the surface normal N. At an angle of incidence of 90°−α to the surface normal N, the cone shell 35 has a ratio of transmittance T to reflectance R of 50:50±10%; ideally the ratio T:R is 50:50.

The left laser beam 44A shown in FIG. 3A is divided into the transmitted partial beam 45A and reflected partial beam 46A. The transmitted partial beam 45A enters the left half of the basic body 23 through the cone shell 35, is reflected three times by total internal reflection at the first inner lateral surface 27, the first outer lateral surface 28 and the second inner lateral surface 31 and leaves the basic body 23 in the left half at the second outer lateral surface 32 as a deflected upper partial beam 48A.

The reflected partial beam 46A is incident on the opposite right-hand side of the cone shell 35 at an angle of incidence of 3*α−90° to the surface normal N. The properties of the cone shell 35, in particular the dependence of the transmittance on the angle of incidence, are adjusted in such a way that the transmittance T for the angle of incidence of 3*α−90° is greater than 90%; ideally T is 99%. The reflected partial beam 46A is predominantly transmitted and enters the right half of the basic body 23 as a partial beam 47A. The partial beam 47A is reflected twice by total internal reflection at the first outer lateral surface 28 and the second inner lateral surface 31 and leaves the basic body 23 in the right half at the second outer lateral surface 32 as a deflected lower partial beam 49A.

The right laser beam 44B shown in FIG. 3B is divided into the transmitted partial beam 45B and the reflected partial beam 46B. The transmitted partial beam 45B enters the right half of the basic body 23 through the cone shell 35, is reflected three times by total internal reflection at the first inner lateral surface 27, the first outer lateral surface 28 and the second inner lateral surface 31, and leaves the basic body 23 in the right half at the second outer lateral surface 32 as a deflected upper partial beam 48B.

The reflected partial beam 46B is incident on the opposite left-hand side of the cone shell 35 at an angle of incidence of 3*α−90° to the surface normal N. The properties of the cone shell 35, in particular the dependence of the transmittance on the angle of incidence, are adjusted in such a way that the transmittance T for the angle of incidence of 3*α−90° is greater than 90%; ideally T is 99%. The reflected partial beam 46B is predominantly transmitted and enters the left half of the basic body 23 as a partial beam 47B. The partial beam 47B is reflected twice by total internal reflection at the first outer lateral surface 28 and the second inner lateral surface 31 and leaves the basic body 23 in the left half at the second outer lateral surface 32 as a deflected lower partial beam 49B.

The opening angle 2*α of the cone shell 35 is not equal to 90° so that the angles of incidence of the transmitted partial beams 45A, 45B and reflected partial beams 46A, 46B are different from one another. The transmitted partial beams 45A, 45B are incident on the cone shell 35 at an angle of incidence of 90°−α to the surface normal N, and the reflected partial beams 46A, 46B are incident at an angle of incidence of 3*α−90° to the surface normal N. At an opening angle of the cone shell 35 of 90°, both the transmitted partial beams 45A, 45B and the reflected partial beams 46A, 46B would be incident on the cone shell 35 at an angle of incidence of 45° to the surface normal N.

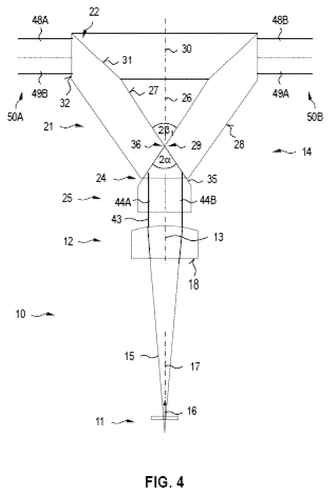

FIG. 4 shows the optical system 14 of FIG. 2 with a deflected laser beam composed of the partial beams 48A, 49A of FIG. 3A and the partial beams 48B, 49B of FIG. 3B.

The deflected upper partial beam 48A and deflected lower partial beam 49B leave the optical system 14 and generate a left 180° laser line 50A. The deflected upper partial beam 48B and deflected lower partial beam 49A leave the optical system 14 and generate a right 180° laser line 50B. The 360° laser line that the optical system 14 generates is composed of the left 180° laser line 50A and the right 180° laser line 50B.

The opening angle of the cone shell 35 that is different from 90° ensures that the angle of incidence of the transmitted and reflected partial beams are different from one another and the dependence of the transmittance on the angle of incidence can be utilized. The deflected laser beam is composed of a transmitted partial beam of one beam half and a reflected partial beam of the other beam half, so that the deflected laser beam which leaves the optical system 14 has all diffraction orders and can generate a sharply delimited laser line with an opening angle of 360° on a projection surface.

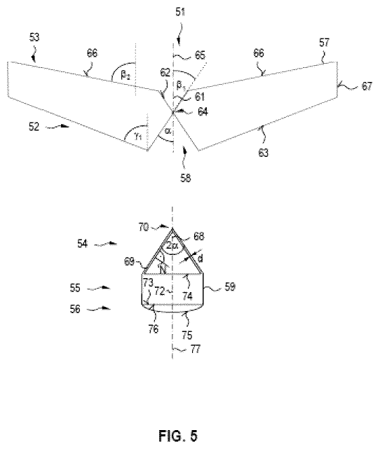

FIG. 5 shows a further embodiment of an optical system 51 according to the invention with a first cone optical unit 52, a second cone optical unit 53, and a further cone optical unit 54. The optical system 51 differs from the optical system 14 in that a collimation optical unit is integrated; in the case of the optical system 14, the collimation optical unit is designed as a separate optical unit.

In addition to the cone optical units 52, 53, 54, the optical system 51 has a cylindrical optical unit 55 and a collimation optical unit 56. The cone optical units 52, 53, 54 are necessary optical units of the optical system 51, whereas the cylindrical optical unit 55 and the collimation optical unit 56 are optional optical units.

The first cone optical unit 52 and second cone optical unit 53 are integrated into one basic body 57 and formed in one piece. The basic body 57 has a conical recess 58, which serves as a receptacle for the further cone optical unit 54. The further cone optical unit 54 is formed in one piece with the cylindrical optical unit 55 and the collimation optical unit 56; the optical units 54, 55, 56 are integrated into a further basic body 59.

The first cone optical unit 52, like the first cone optical unit 21, is designed in the form of a first negative cone section having a first cone axis 61 and has a conical first inner lateral surface 62 with a first opening angle 2*β₁, a conical first outer lateral surface 63 with an opening angle 2*γ₁, and a first cone vertex 64.

The second cone optical unit 53, like the second cone optical unit 22, is designed in the form of a second negative cone section with a second cone axis 65 and has a conical second inner lateral surface 66 with a second opening angle 2*β₂ and a second outer lateral surface 67.

The further cone optical unit 54, like the further cone optical unit 24, is designed in the form of a positive cone with a cone axis 68 and has a circular base, a cone shell 69 with an opening angle 2*α, and a cone vertex 70. The opening angle 2*α of the cone shell 69 is different from 90°, and the cone shell 69, like the cone shell 35, is made of a material that differs from the other further cone optical unit 54 in at least one of the properties refractive index n, transmittance T, and reflectance R.

The cone shell 69 is made of a dielectric material or a metal such as silver (Ag), aluminum (Al), silver dioxide (SiO₂) and titanium dioxide (TiO₂). The cone shell 69 is designed in such a way that for an angle of incidence of 90°−α to the surface normal N a ratio of transmittance T to reflectance R is 50:50±10%, and for an angle of incidence of 3*α−90° to the surface normal N the transmittance T is greater than 90%. Ideally, the ratio T:R is 50:50 for an angle of incidence of 90°−α to the surface normal N, and T equals 99% for an angle of incidence of 3*α−90° to the surface normal N.

The cylindrical optical unit 55 is cylindrical with a cylinder axis 72 and has a plane entrance surface 73 and a plane exit surface 74. The collimation optical unit 56 has a curved entrance surface 75 and a plane exit surface 76, which coincides with the entrance surface 73 of the cylindrical optical unit 55. The optical axis 77 of the collimation optical unit 56 is defined as a straight line that runs through the center of curvature of the curved entrance surface 75 and is perpendicular to the plane exit surface 76. The entrance and exit surfaces 73, 74, 75, 76 of the cylindrical optical unit 55 and the collimation optical unit 56 are designed as transmission surfaces for the wavelength and polarization of the laser beam source 11.

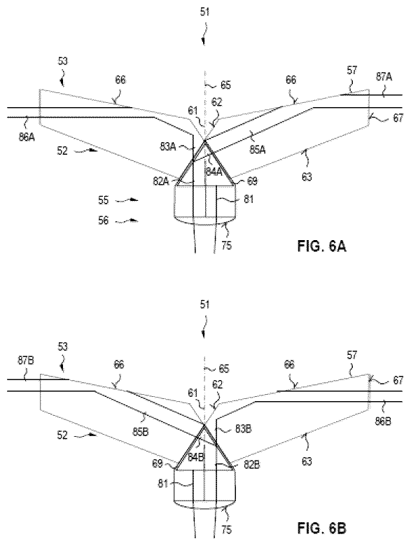

FIGS. 6A, B show the beam path of a laser beam in the optical system 51 according to the invention, which can replace the optical system 14 in the laser system 10 of FIG. 1. The optical system 51 comprises the first cone optical unit 52, the second cone optical unit 53, the further cone optical unit 54, the cylindrical optical unit 55, and the collimation optical unit 56.

The laser beam source 11 generates the divergent laser beam 15, which is incident on the curved entrance surface 75, which shapes a collimated laser beam 81. The collimated laser beam 81 propagates through the cylindrical optical unit 55 and the further cone optical unit 54 and is incident on the cone shell 69 at an angle of incidence of 90°−α to the surface normal N. The cone vertex 70 divides the laser beam 81 into a left laser beam 82A and a right laser beam 82B, which propagate through the first and second cone optical units 52, 53 along different paths.

The left laser beam 82A shown in FIG. 6A is divided into a transmitted partial beam 83A and a reflected partial beam 84A. The transmitted partial beam 83A is reflected twice by total internal reflection at the first inner lateral surface 62 and the second inner lateral surface 66 and leaves the basic body 57 at the second outer lateral surface 67 as a deflected lower partial beam 86A.

The reflected partial beam 84A is incident on the opposite right-hand side of the cone shell 69 at an angle of incidence of 3*α−90° to the surface normal N. Since the transmittance T is greater than 90% for this angle of incidence, the reflected partial beam 84A is predominantly transmitted and enters the left half of the basic body 23 as a partial beam 85A. The partial beam 85A is reflected once by total internal reflection at the second inner lateral surface 66 and leaves the basic body 57 at the second outer lateral surface 67 as a deflected upper partial beam 87A.

The right laser beam 82B shown in FIG. 6B is divided into a transmitted partial beam 83B and a reflected partial beam 84B. The transmitted partial beam 83B is reflected twice by total internal reflection at the first inner lateral surface 62 and the second inner lateral surface 66 and leaves the basic body 57 at the second outer lateral surface 67 as a deflected lower partial beam 86B.

The reflected partial beam 84B is incident on the opposite left-hand side of the cone shell 69 at an angle of incidence of 3*α−90° to the surface normal N. Since the transmittance T is greater than 90% for this angle of incidence, the reflected partial beam 84B is predominantly transmitted and enters the right half of the basic body 57 as a partial beam 85B. The partial beam 85B is reflected once by total internal reflection at the second inner lateral surface 66 and leaves the basic body 57 at the second outer lateral surface 67 as a deflected upper partial beam 87B.

The deflected lower partial beam 86A and deflected upper partial beam 87B leave the optical system 51 and generate a left 180° laser line. The deflected lower partial beam 86B and deflected upper partial beam 87A leave the optical system 51 and generate a right 180° laser line. The 360° laser line that the optical system 51 generates is composed of the left 180° laser line and the right 180° laser line.

1.-11. (canceled)

12. An optical system (14; 51) for generating a 360° laser line (50A, 50B), comprising:
a first cone optical unit (21; 52) which is configured in a form of a first negative cone section with a first cone axis (26; 61) and which has a conical first inner lateral surface (27; 62) with a first opening angle (2*β₁), a conical first outer lateral surface (28; 63), and a first cone vertex (29; 64);
a second cone optical unit (22; 53) which is configured in a form of a second negative cone section with a second cone axis (30; 65) and which has a conical second inner lateral surface (31; 66) with a second opening angle (2*β₂) and a second outer lateral surface (32; 67); and
a third cone optical unit (24; 54) which has a third cone axis (33; 68), a cone shell (35; 69) with an opening angle (2*α), and a second cone vertex (36; 70), wherein the opening angle (2*α) of the cone shell (35; 69) differs from 90°.

13. The optical system (14; 51) as claimed in claim 12, wherein the cone shell (35; 69) has at an angle of incidence of 90°−α to a surface normal (N) a ratio of transmittance (T) to reflectance (R) of 50:50±10%.

14. The optical system (14; 51) as claimed in claim 13, wherein the cone shell (35; 69) has at an angle of incidence of 3*α−90° to the surface normal (N) a transmittance (T) of greater than 90%.

15. The optical system (14; 51) as claimed in claim 12, wherein the first opening angle (2*β₁) of the conical first inner lateral surface (27; 62) matches the opening angle (2*α) of the cone shell (35; 69).

16. The optical system (14; 51) as claimed in claim 12, wherein the first cone vertex (29; 64) of the first cone optical unit (21; 52) coincides with the second cone vertex (36; 70) of the third cone optical unit (24; 54).

17. The optical system (14; 51) as claimed in claim 12, wherein the first cone optical unit (21; 52) is integrated into a basic body (23; 57) which has a conical recess (41; 58) for the third cone optical unit (24; 54) and wherein a conical shape of the conical recess (41; 58) corresponds to the third cone optical unit (24; 54).

18. The optical system (14; 51) as claimed in claim 17, wherein the second cone optical unit (22; 53) is integrated into the basic body (23; 57) and is formed in one piece with the first cone optical unit (21; 52).

19. The optical system (14; 51) as claimed in claim 12, wherein the first cone axis (25; 61) of the first cone optical unit (21; 52), the second cone axis (30; 65) of the second cone optical unit (22; 53), and the third cone axis (33) of the third cone optical unit (24; 54) are disposed coaxially to one another.

20. The optical system (14; 51) as claimed in claim 12, further comprising a cylindrical optical unit (25; 55) which is formed in one piece with the third cone optical unit (24; 54).

21. A laser system (10) for generating a 360° laser line (50A, 50B), comprising:
a beam source (11); and
the optical system (14; 51) as claimed in claim 12.

22. The laser system (10) as claimed in claim 21, wherein a laser beam (15) generated by the beam source (11) has a beam distribution in a form of a Gaussian distribution or a Lorentz distribution or a Bessel distribution.
